(19) United States
(12) Patent Application Publication
(10) Pub. No.: US 2011/0134646 A1
(43) Pub. Date: Jun. 9, 2011

(54) LIGHT UNIFORMIZATION STRUCTURE AND LIGHT EMITTING MODULE

(75) Inventors: Wen Hsun Yang, Taipei City (TW); Hui Hsiung Lin, Hsinchu County (TW); Han Tsung Hsueh, Taipei City (TW)

(73) Assignee: INDUSTRIAL TECHNOLOGY RESEARCH INSTITUTE, Hsinchu (TW)

(21) Appl. No.: 12/708,147

(22) Filed: Feb. 18, 2010

(30) Foreign Application Priority Data
Dec. 8, 2009 (TW) 098141820

(51) Int. Cl. F21V 5/00

(52) U.S. Cl. 362/311.06

(57) ABSTRACT

A light uniformization structure and light emitting module is related to a light uniformization structure includeing a first material layer having a plurality of microstructures in a surface thereof, a second material layer having a plurality of microstructures in a surface thereof, and a spacer layer. The spacer layer is located between the first material layer and the second material layer, and a refractive index of the spacer layer is smaller than a refractive index of the first material layer and a refractive index of the second material layer.

### CROSS-REFERENCE TO RELATED APPLICATIONS

This non-provisional application claims priority under 35 U.S.C. §119(a) on Patent Application No(s). 098141820 filed in Taiwan, R.O.C. on Dec. 8, 2009, the entire contents of which are hereby incorporated by reference.

### BACKGROUND

1. Field of Invention

The present invention relates to a light source module, and more particularly to a light uniformization structure and a light emitting module.

2. Related Art

With the advantages of small volume, low power consumption, and long service life, the light emitting diode (LED) is the most effective among all other novel light emitting elements in terms of energy saving and carbon reduction. In recent years, the LED has been widely applied to illumination devices. Moreover, with increasing awareness in green power, it is expected that LED illumination devices will gradually replace the conventional illumination devices. However, the light emitting principle and light emitting mode of the LED are quite different from the conventional light sources such as bulbs and tubes. Therefore, when the LED is applied to illumination devices, problems of non-uniform light source or poor luminous efficiency can occur.

### SUMMARY

Accordingly, the present invention is a light uniformization structure and a light emitting module, so as to solve the problems in the prior art.

The light uniformization structure of the present invention comprises a first material layer, a second material layer, and a spacer layer.

The spacer layer is located between the first material layer and the second material layer, and a refractive index of the spacer layer is smaller than a refractive index of the first material layer and a refractive index of the second material layer.

The first material layer is light transmissive, and a plurality of microstructures is formed in a first surface of the first material layer. The second material layer is light transmissive, and a plurality of microstructures is formed in a first surface of the second material layer.

The spacer layer can be an air layer or a light-transmissive spacer material layer.

A second surface of the first material layer opposite to the first surface thereof faces the first surface of the second material layer. Moreover, the second surface of the first material layer can touch apexes of the microstructures in the first surface of the second material layer.

In addition, a base material can be disposed on and touch the second surface of the first material layer, and/or a base material can be disposed on and touch a second surface of the second material layer opposite to the first surface thereof.

Moreover, the light uniformization structure of the present invention can be applied in a light emitting module, so as to receive light emitted by a light source module, uniformize the received light, and transmit the uniformized light.

Here, at least one light source module is located between the light uniformization structure and a base plate. A surface of the light uniformization structure faces a light emitting surface of the light source module, so as to receive light generated by the light source module.

The light uniformization structure and the light emitting module of the present invention use a low refractive index layer and surface structures in combination to achieve a uniform light field and high transmittance. Moreover, the total reflection inside the light uniformization structure is reduced by using a geometrical-optics refraction mechanism (high refractive index layers clamping low refractive index layer), thereby improving the luminous efficiency of the light uniformization structure and the light emitting module.

### BRIEF DESCRIPTION OF THE DRAWINGS

The present invention will become more fully understood from the detailed description given herein below for illustration only, and thus are not limitative of the present invention, and wherein:

FIG. 1 is a schematic structural view of a light uniformization structure according to a first embodiment of the present invention;

FIG. 2 is a schematic structural view of a first embodiment of a microstructure film;

FIG. 3 is a schematic structural view of a second embodiment of a microstructure film;

FIG. 4A is a schematic structural view of a third embodiment of a microstructure film;

FIG. 4B is a schematic structural view of a fourth embodiment of a microstructure film;

FIG. 5 is a schematic structural view of a fifth embodiment of a microstructure film;

FIG. 6 is a schematic structural view of a sixth embodiment of a microstructure film;

FIG. 7 is a schematic structural view of a seventh embodiment of a microstructure film;

FIG. 8 is a schematic structural view of an embodiment of an aspherical microstructure;

FIG. 9 is a schematic structural view of an eighth embodiment of a microstructure film;

FIG. 10 is a schematic structural view of a light uniformization structure according to a second embodiment of the present invention;

FIG. 11 is a schematic structural view of a light uniformization structure according to a third embodiment of the present invention;

FIG. 12 is a schematic structural view of a light uniformization structure according to a fourth embodiment of the present invention;

FIG. 13 is a schematic structural view of a light uniformization structure according to a fifth embodiment of the present invention;

FIG. 14 is a schematic structural view of a ninth embodiment of a microstructure film;

FIG. 15 is a schematic structural view of a tenth embodiment of a microstructure film;

FIG. 16 is a schematic structural view of a light uniformization structure according to a sixth embodiment of the present invention;

FIG. 17 is a schematic structural view of a light uniformization structure according to a seventh embodiment of the present invention;

FIG. 18 is a schematic structural view of a light uniformization structure according to an eighth embodiment of the present invention;

FIG. 19 is a schematic structural view of a light uniformization structure according to a ninth embodiment of the present invention;

FIG. 20 is a schematic structural view of a light emitting module according to a first embodiment of the present invention;

FIG. 21 is a schematic structural view of a light emitting module according to a second embodiment of the present invention;

FIG. 22 is a schematic structural view of a light emitting module according to a third embodiment of the present invention;

FIG. 23 is a schematic side view of the light emitting module according to the third embodiment of the present invention;

FIG. 24 is a schematic structural view of a light emitting module according to a fourth embodiment of the present invention;

FIG. 25 is a schematic structural view of a light emitting module according to a fifth embodiment of the present invention;

FIG. 26 is a schematic structural view of a light emitting module according to a sixth embodiment of the present invention; and

FIG. 27 is a graph of a luminous test on a light emitting module of the present invention and a light emitting module using a commercially available diffuser.

### DETAILED DESCRIPTION

The present invention provides a light uniformization structure and a light emitting module that use a low refractive index layer and surface structures in combination to achieve a uniform light field and high transmittance. Moreover, the total reflection inside the light uniformization structure is reduced by using a geometrical-optics refraction mechanism (high refractive index layers clamping low refractive index layer), thereby improving the luminous efficiency of the light uniformization structure and the light emitting module.

In the following descriptions, “first” and “second” are merely used for denoting two elements (two surfaces, two material layers, or two basic materials), instead of specifying particular elements or sequences.

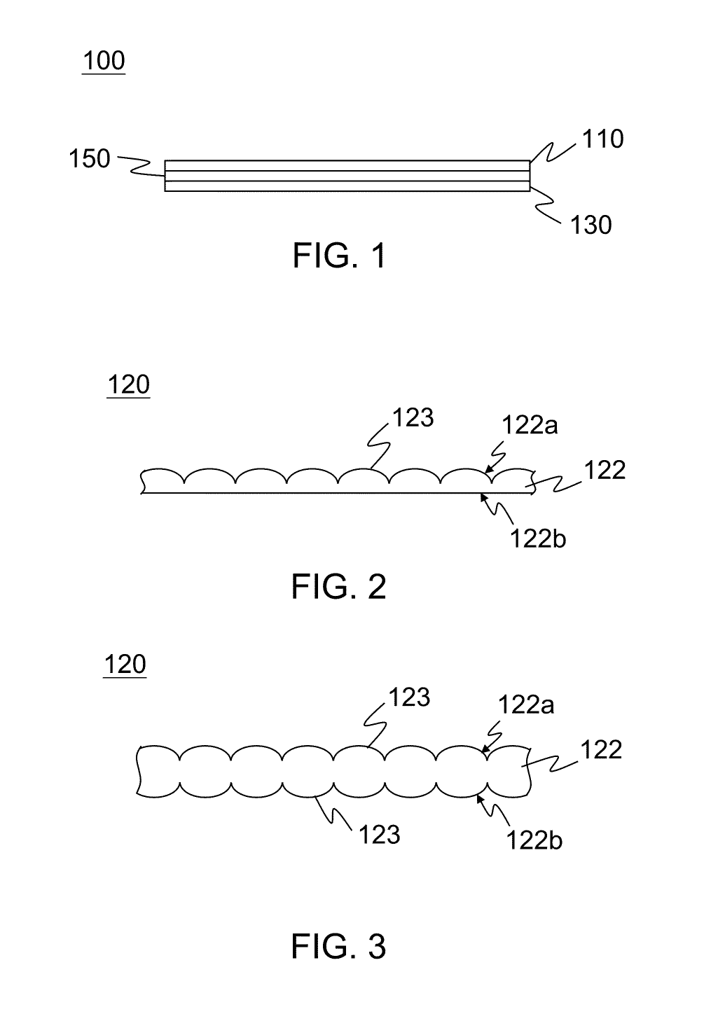

FIG. 1 shows a light uniformization structure according to an embodiment of the present invention.

Referring to FIG. 1, a light uniformization structure 100 comprises two microstructure films 110, 130 and a spacer layer 150. The microstructure films 110, 130 and the spacer layer 150 are light transmissive.

The microstructure film 110, the spacer layer 150, and the microstructure film 130 are laminated in sequence.

Each of the microstructure films 110, 130 has a plurality of microstructures (not shown), and a refractive index of a material forming the microstructures is greater than a refractive index of the spacer layer 150.

Here, the spacer layer 150 can be an air layer, that is, the microstructure films 110, 130 are spaced from each other by a particular distance, such that air is present between the microstructure films 110, 130.

Moreover, the spacer layer 150 can be a material layer having a refractive index of 1 to 1.5, referred to spacer material layer for clear description. Moreover, the refractive index of the material to be formed into the microstructures can be greater than 1.5. A difference between the refractive index of the spacer layer 150 and the refractive index of the material forming the microstructures can be equal to or greater than 0.08.

The spacer material layer can be made of an ultraviolet (UV) glue or polymethylmethacrylate (PMMA) having a refractive index smaller than 1.5. Furthermore, in manufacturing, the microstructure film 110, the spacer material layer 150 and the microstructure film 130 can be adhered to each other in order.

Here, the spacer layer 150 having a low refractive index and the microstructures can be used to refract light, so as to achieve a uniform light field and high transmittance.

Referring to FIG. 2, each microstructure film 120 (that is, the microstructure film 110/130 in FIG. 1) can be a material layer 122 having a refractive index greater than the spacer layer 150. The material layer 122 can be made of a UV glue, polycarbonate (PC), or poly(ethylene terephthalate) (PET) having a refractive index greater than 1.5.

The material layer 122 has two opposite surfaces, which are respectively referred to as a first surface 122a and a second surface 122b below for ease of illustration.

A plurality of microstructures 123 is formed in the first surface 122a of the material layer 122. Here, the microstructures 123 can be distributed in the first surface 122a of the material layer 122, or the microstructures 123 are connected to each other to form the first surface 122a of the material layer 122. In other words, a portion of the first surface 122a of the material layer 122 is formed into the microstructures 123, or whole first surface 122a of the material layer 122 is formed into the microstructures 123.

In addition, a plurality of microstructures 123 may also be formed in the second surface 122b of the material layer 122 (as shown in FIG. 3).

In other words, each microstructure film 120 (that is, the microstructure film 110/130 in FIG. 1) may have microstructures in only one surface, or have microstructures in both surfaces.

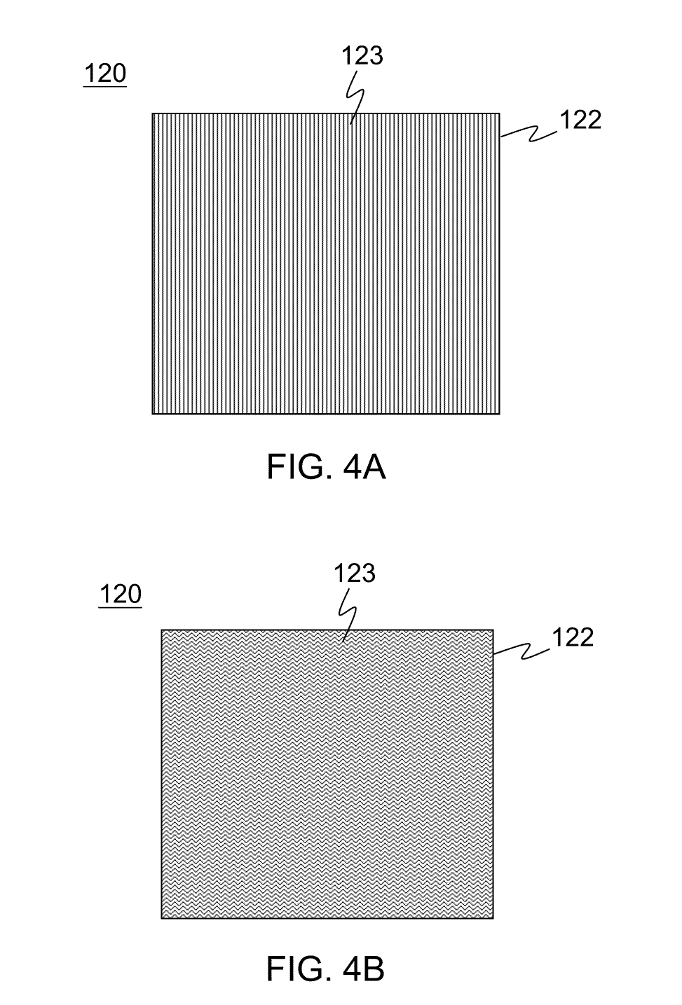

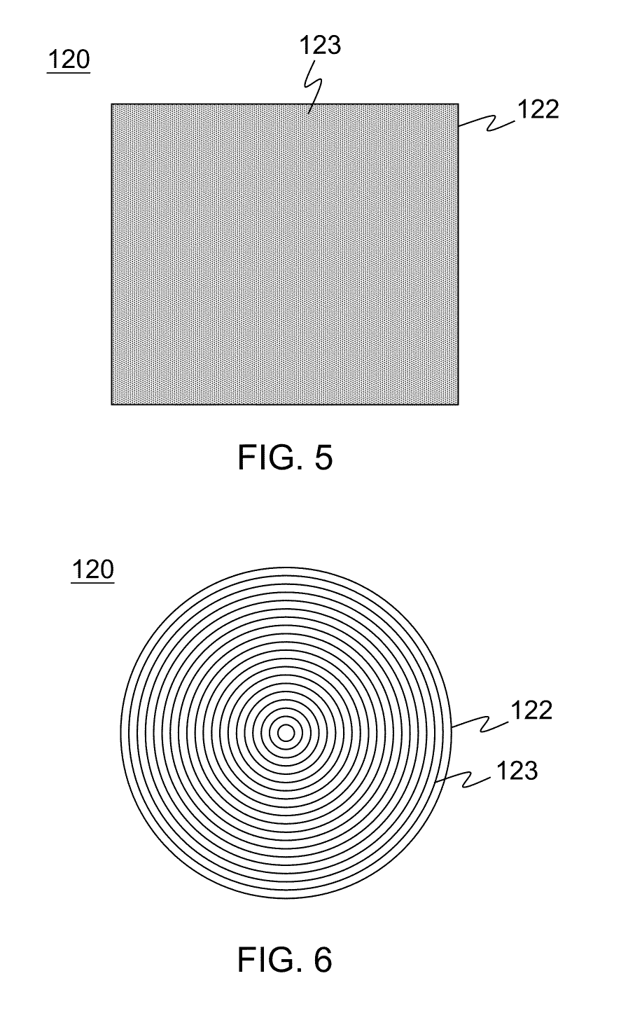

Here, when the surfaces of the microstructure film 120 are viewed from the top, the microstructures 123 in the surfaces of the material layer 122 (the first surface 122a and the second surface 122b) form a stripe pattern (as shown in FIGS. 4A and 4B), a mesh pattern (as shown in FIG. 5), or a concentric-circle pattern (as shown in FIG. 6).

The stripe pattern can be straight stripes (as shown in FIG. 4A), curved stripes (as shown in FIG. 4B), or a mixture of straight stripes and curved stripes (not shown).

Microscopically, in the mesh pattern, each point may have a circular, rectangular, or other geometrical shapes.

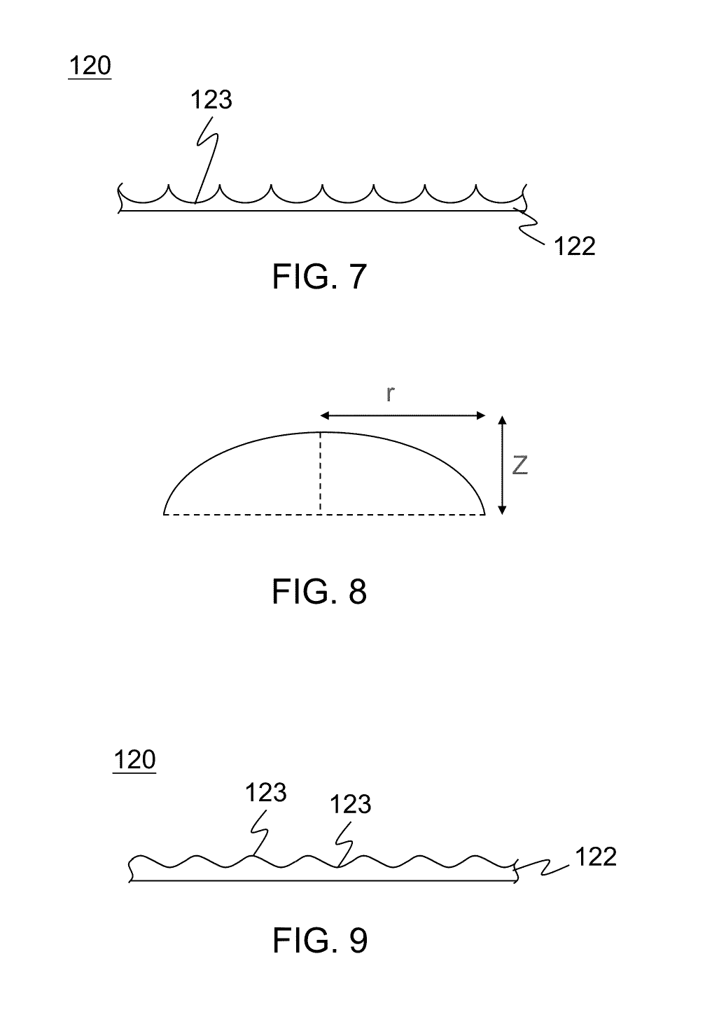

In addition, when the microstructure film 120 is viewed from the top, each microstructure 123 can be a raised structure (as shown in FIG. 2) or a recessed structure (as shown in FIG. 7).

The raised structure may have a shape of a columnar structure, a V-shaped structure, a spherical structure, or an aspherical structure. The recessed structure may have a shape of a columnar structure, a V-shaped structure, a spherical structure, or an aspherical structure.

Here, referring to FIG. 8, the aspherical structure is a curved surface that satisfies the following Equation 1.

$$Z = \frac{{cr}^{2}}{( 1 + {( 1 - ( 1 + k ) {c}^{2} {r}^{2} )}^{\frac{1}{2}} )} \qquad Equation 1$$

In the equation, Z represents a longitudinal radius, that is, a perpendicular distance between a tangent of an apex of the curved surface and a line passing through a lowest point of the curved surface and parallel to the tangent of the apex; c is a curvature of the central apex of the aspherical structure (that is, the curved surface); k is a conic constant; and r is a radial radius, that is, radius of curvature.

Moreover, the microstructures 123 in the same surface (the first surface or the second surface) can be structures of the same shape (as shown in FIGS. 2 and 7) or structures of different shapes (as shown in FIG. 9).

For ease of description, the material layers 122 serving as the microstructure films 110, 130 are respectively referred to a first material layer 112 and a second material layer 132.

The first material layer 112 may have microstructures in only one surface, or have microstructures in both surfaces. The second material layer 132 may have microstructures in only one surface, or have microstructures in both surfaces.

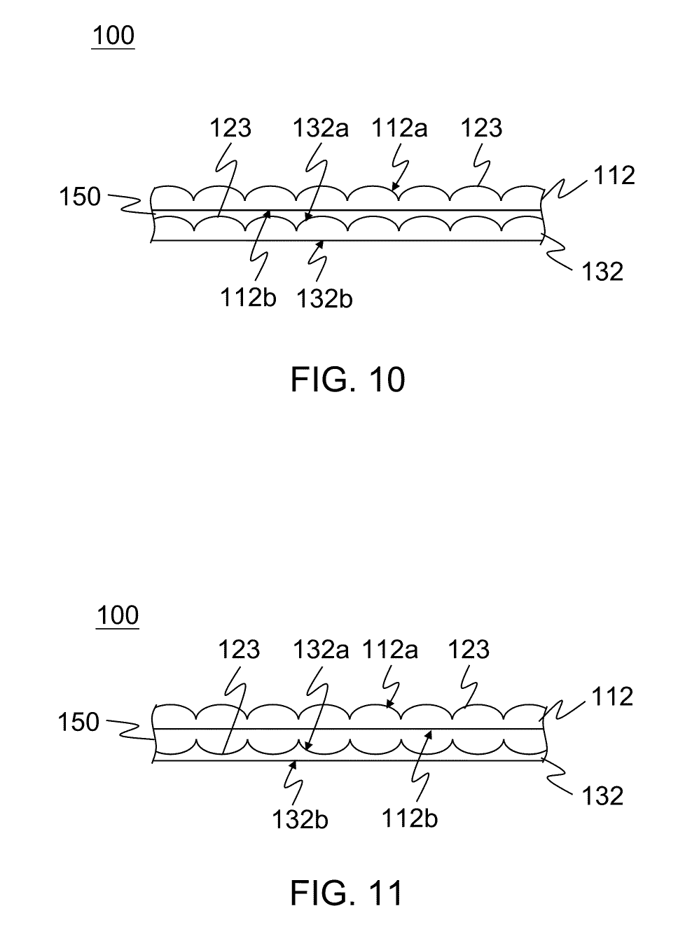

Referring to FIGS. 10 and 11, for ease of description, a case where the first surface 112a of the first material layer 112 has the microstructures 123 and the first surface 132a of the second material layer 132 has the microstructures 123 is taken as an example. The microstructures 123 in the first material layer 112 and the microstructures 123 in the second material layer 132 may have the same design (as shown in FIG. 10), or different designs (as shown in FIG. 11).

The second surface 112b of the first material layer 112 faces the first surface 132a of the second material layer 132.

The second surface 112b of the first material layer 112 and the first surface 132a of the second material layer 132 respectively touch two opposite surfaces of the spacer layer 150.

Here, the second surface 112b of the first material layer 112 can be spaced from apexes of the microstructures 123 in the first surface 132a of the second material layer 132, such that a medium (air or a particular material) serving as the spacer layer 150 is filled between the first material layer 112 and the second material layer 132, that is, the spacer layer 150 completely isolates the first material layer 112 from the second material layer 132.

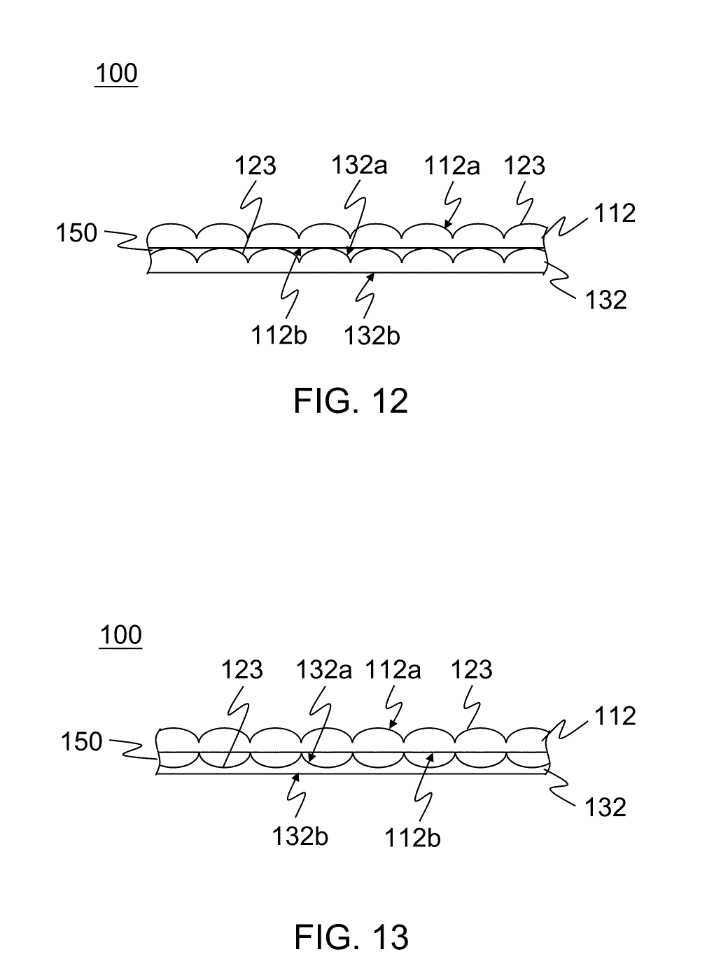

Moreover, the second surface 112b of the first material layer 112 can touch the apexes of the microstructures 123 in the first surface 132a of the second material layer 132, such that the medium (air or a particular material) serving as the spacer layer 150 is filled in a space formed between two neighboring microstructures 123 in the second surface 112b of the first material layer 112 and the first surface 132a of the second material layer 132, as shown in FIGS. 12 and 13.

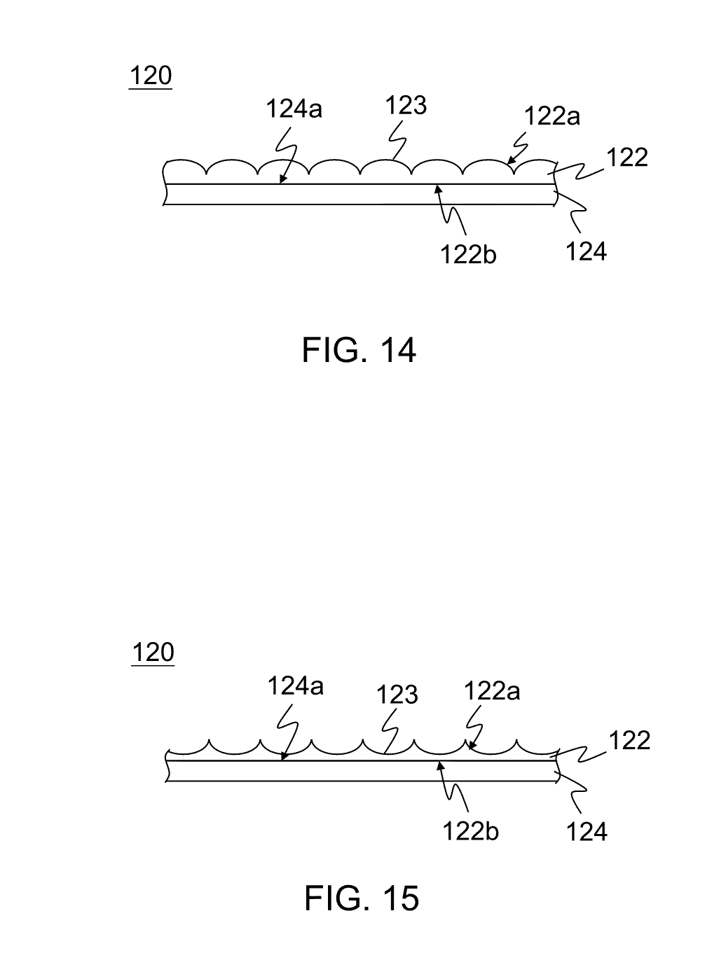

Moreover, referring to FIGS. 14 and 15, each microstructure film 120 (that is, the microstructure film 110/130 in FIG. 1) may also be formed by a material layer 122 (that is, the first material layer 112 or the second material layer 132) and a base material 124.

The material layer 122 is formed on one surface 124a of the base material 124.

The microstructures 123 are formed on the first surface 122a of the material layer 122, and the second surface 122b of the material layer 122 touches the base material 124.

The base material 124 can be a material having a refractive index close to the refractive index of the material layer 122. Here, the base material 124 can be a material having a refractive index equal to or greater than 1.49. Moreover, the base material 124 can be such a material that a difference between a refractive index of the material and the refractive index of the material layer 122 is smaller than or equal to 0.075. That is to say, a difference between the refractive index of the base material 124 and the refractive index of the material layer 122 is smaller than or equal to 0.075. For example, the base material 124 can be PMMA, PC, PET, or the like.

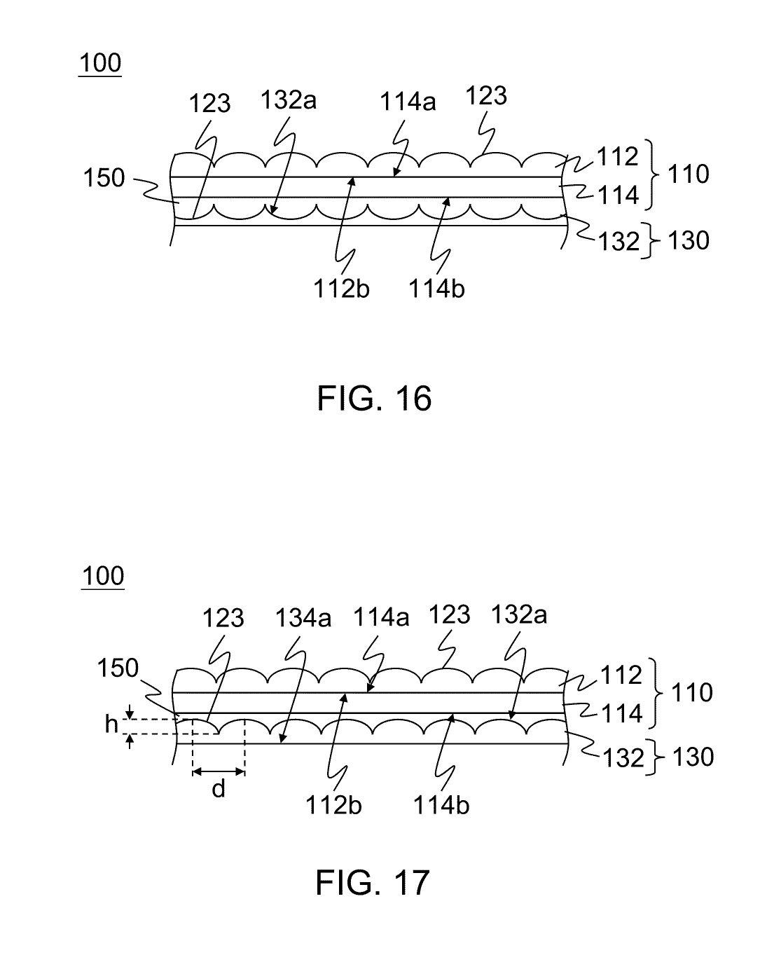

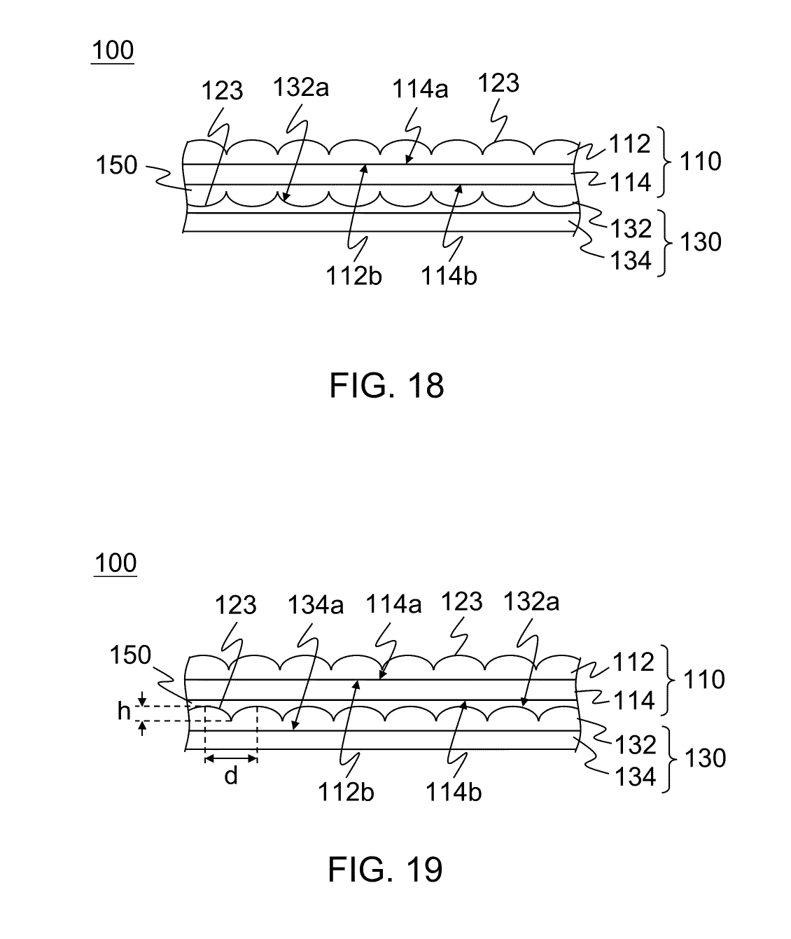

In the light uniformization structure 100, as shown in FIGS. 11 to 13, both of the two microstructure films 120 (that is, the microstructure films 110, 130) can adopt a structure formed by a single material layer 122 (that is, the first and the second material layers 112, 132). Alternatively, as shown in FIGS. 16 and 17, one microstructure film 120 (that is, the microstructure film 130) adopts a structure formed by a single material layer 122 (that is, the second material layer 132), the other microstructure film 120 (that is, the microstructure film 110) adopts a structure formed by the material layer 122 (that is, the first material layer 112) and the base material 124 (that is, a base material 114). Alternatively, as shown in FIGS. 18 and 19, both of the two microstructure films 120 (that is, the microstructure films 110, 130) adopt the structure formed by the material layer 122 (that is, the first and the second material layers 112, 132) and the base material 124 (that is, base materials 114, 134).

Referring to FIGS. 16 and 17, when one microstructure film 110 adopts the structure formed by the material layer (the first material layer 112) and the base material 114, one surface 114a of the base material 114 of the microstructure film 110 touches the first material layer 112, and another surface 114b of the base material 114 opposite to the surface 114a touches the spacer layer 150. In other words, the other surface 114b of the base material 114 touches one side of the spacer layer 150 opposite to the second material layer 132.

Referring to FIGS. 18 and 19, when both of the two microstructure films 110, 130 adopt the structure formed by the material layer and the base material, the other surface 114b of the base material 114 touches the side of the spacer layer 150 opposite to the second material layer 132. The surface 114a of the base material 114 of the microstructure film 110 touches the first material layer 112, and the other surface 114b of the base material 114 opposite to the surface 114a touches the spacer layer 150. One surface 134a of the base material 134 of the microstructure film 130 touches the second material layer 132, and the spacer layer 150 is clamped between the second material layer 132 and the base material 114. In other words, the other surface 114b of the base material 114 and the surface (the first surface 132a) of the second material layer 132 opposite to the base material 134 respectively touch the two opposite surfaces of the spacer layer 150.

In manufacturing, the microstructure film 120 formed by a single material layer 122 can be manufactured through injection molding of plastic material, or by hot extrusion molding using a roller die having a stamp structure corresponding to the microstructures 123 to be formed.

The microstructure film 120 formed by the material layer 122 and the base material 124 can be manufactured by using a plastic material as the base material 124, and then coating a layer of glue (for example, UV glue) having a refractive index close to the refractive index of the plastic material onto the base material 124 by roller coating using a roller die. Moreover, during rolling, the stamp structure of the roller die is roller-printed on the glue, so as to form the microstructures 123.

For the stamp structure on the roller die, a stamp pattern corresponding to the microstructures 123 can be cut on copper or nickel by using a diamond knife according to the shape of the microstructures 123 to be formed.

In the present invention, at least one of the designs of the microstructure film 120 (that is, the microstructure film 110/130) and the spacer layer 150 shown in FIGS. 2 to 19 and corresponding descriptions thereof can be applied in the light uniformization structure 100 shown in FIG. 1 and corresponding descriptions thereof at will.

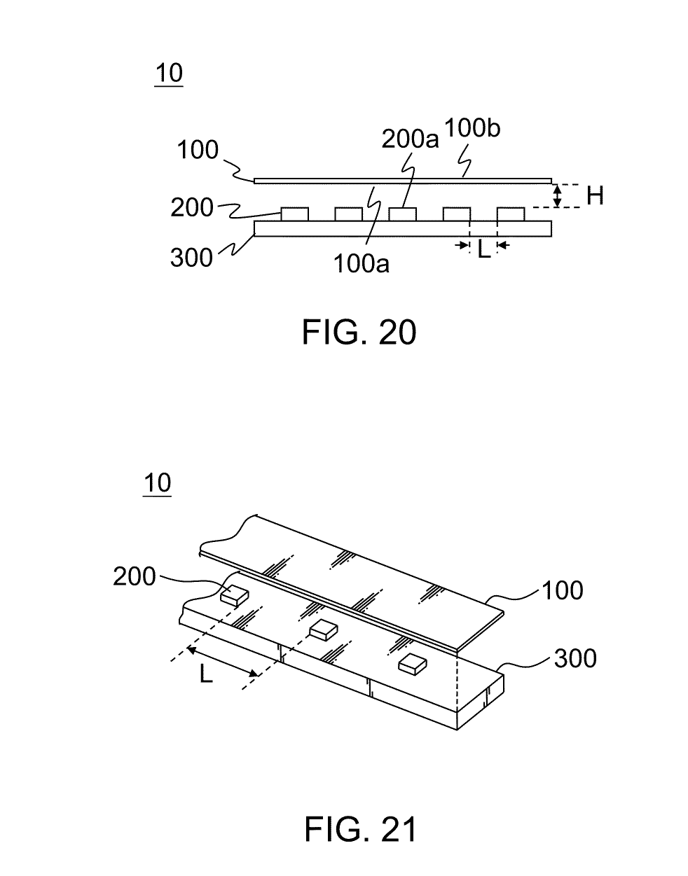

Referring to FIGS. 20 and 21, the light uniformization structure 100 of the present invention can be applied in a light emitting module 10, so as to receive light emitted by a light source module 200, uniformize the received light, and transmit the uniformized light.

A plurality of light source modules 200 is located between the light uniformization structure 100 and a base plate 300.

One surface 100a of the light uniformization structure 100 faces light emitting surfaces 200a of the light source modules 200, so as to receive light generated by the light source modules 200.

The light uniformization structure 100 uses a low refractive index layer (that is, the spacer layer) and high refractive index layers having surface structures (that is, the first and the second material layers) to uniformize the received light by multiple refractions, and transmits the uniformized light through another surface 100b of the light uniformization structure 100 opposite to the surface 100a.

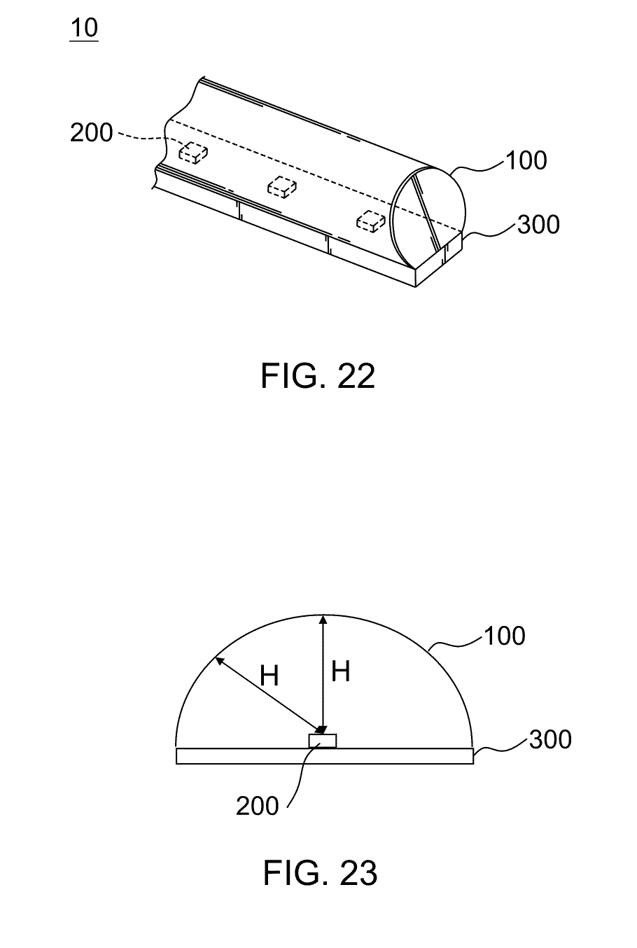

The light uniformization structure 100 can be disposed spaced from the light source modules 200 and the base plate 300 by a particular distance, as shown in FIGS. 20 and 21. In addition, edges of the light uniformization structure 100 can touch the base plate 300, so as to form an accommodation space, and the light source modules 200 are disposed in the accommodation space, as shown in FIG. 22.

Moreover, a ratio L/H of a distance L between two neighboring light source modules 200 to a distance H between the light source module 200 and the light uniformization structure 100 can be designed as 0.5≦L/H≦1. Taking FIG. 20 as an example, the light source module 200 and the light uniformization structure 100 are maintained at a distance H, such that the ratio L/H can be 1. FIG. 23 is a side view of the embodiment of FIG. 22. Referring to FIG. 23, in this embodiment, although the edges of the light uniformization structure 100 can touch the base plate 300 to form a semicircle, the distance H between the light source module 200 and the light uniformization structure 100 remains constant, such that L/H can be 1; however, the present invention is not limited thereto.

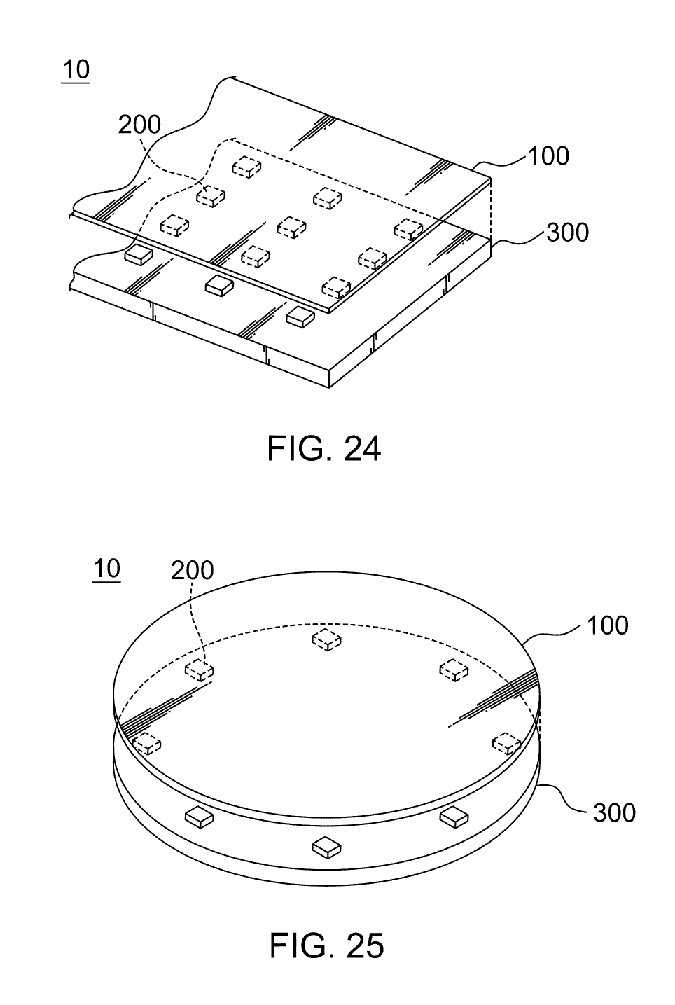

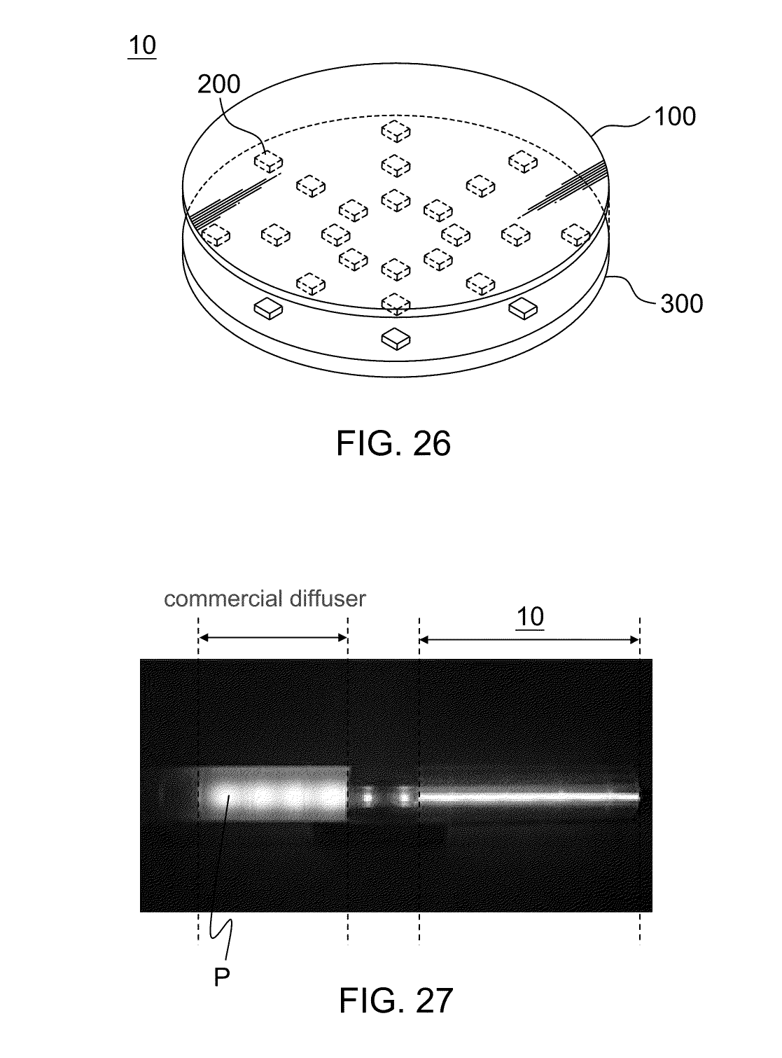

Here, the light source modules 200 can be point light sources or linear light sources. The light source modules 200 can be arranged in an one-dimensional configuration (as shown in FIGS. 21 and 22) or in a two-dimensional configuration. The two-dimensional configuration can be, for example, an array configuration (as shown in FIG. 24), a circularly symmetric configuration (as shown in FIG. 25), or a radial configuration (as shown in FIG. 26).

The light source modules 200 can be disposed between the light uniformization structure 100 and the base plate 300, and disposed on the base plate 300. The light source modules 200 can be arranged on the base plate 300 in an one-dimensional configuration or in a two-dimensional configuration (for example, array, radial, or circularly symmetric configuration).

The light uniformization structure 100 can uniformize the point light sources formed by the light source modules 200 into linear light sources or surface light sources. Alternatively, the light uniformization structure 100 can uniformize the linear light sources formed by the light source modules 200 into surface light sources.

Here, the light emitting module 10 of FIG. 21 using the light uniformization structure 100 of FIG. 19 is tested. The first material layer 112 uses an UV glue having a refractive index of 1.565, and the second material layer 132 also uses the UV glue having the refractive index of 1.565. The base material 114 uses PET having a refractive index of 1.6, and the base material 134 uses PET having a refractive index of 1.6. The spacer layer 150 uses an UV glue having a refractive index of 1.48. Here, a surface of the base material 134 opposite to the second material layer 132 faces the light source modules 200. Moreover, a ratio h/d of a height h of each microstructure 123 to a distance d between center points of two neighboring microstructures 123 can be 0.5≧h/d≧0.3. In this embodiment, the ratio h/d of the height h of each microstructure 123 to the distance d between center points of two neighboring microstructures 123 is 0.5. Here, the distance d between center points of two neighboring microstructures 123 is 60 μm, the height h of each microstructure 123 is 30 μm, and aspherical microstructures 123 are used. The height of each microstructure 123 refers to a distance between the highest point (apex) and the lowest point of the microstructure 123.

Referring to FIG. 27, the right side in the figure shows the light emitting module of the present invention, and the left side in the figure shows a light emitting module using a commercially available diffuser. Compared with the commercially available diffuser, with the same settings of the height and the light source modules of the light emitting module, the light emitting module 10 of the present invention can generate a uniform linear light source, but the light emitting module using the commercially available diffuser still has visible light points P.

Moreover, the light emitting module 10 of the present invention can reach a transmittance of 90%.

The invention being thus described, it will be obvious that the same may be varied in many ways. Such variations are not to be regarded as a departure from the spirit and scope of the invention, and all such modifications as would be obvious to

one skilled in the art are intended to be included within the scope of the following claims.

What is claimed is:

1. A light emitting module, comprising:
a light uniformization structure, comprising:
a first material layer, being light transmissive and having a first surface and a second surface opposite to each other, wherein a plurality of microstructures is formed in the first surface of the first material layer;
a second material layer, being light transmissive and having a first surface and a second surface opposite to each other, wherein a plurality of microstructures is formed in the first surface of the second material layer; and
a spacer layer, located between the first material layer and the second material layer, wherein a refractive index of the spacer layer is smaller than a refractive index of the first material layer and a refractive index of the second material layer;
a base plate; and
at least one light source module, located between the light uniformization structure and the base plate.

2. The light emitting module according to claim 1, wherein a difference between the refractive index of the spacer layer and the refractive index of the first material layer is equal to or greater than 0.08, and a difference between the refractive index of the spacer layer and the refractive index of the second material layer is equal to or greater than 0.08.

3. The light emitting module according to claim 2, wherein the refractive index of the spacer layer is between 1 and 1.5, the refractive index of the first material layer is equal to or greater than 1.5, and the refractive index of the second material layer is equal to or greater than 1.5.

4. The light emitting module according to claim 1, wherein the second surface of the first material layer faces the first surface of the second material layer.

5. The light emitting module according to claim 4, wherein the second surface of the first material layer touches apexes of the microstructures in the first surface of the second material layer.

6. The light emitting module according to claim 1, wherein the light uniformization structure further comprises:
a base material, a surface of the base material touching the second surface of the first material layer;
wherein the second material layer is located in a side of the base material opposite to the first material layer, and a difference between a refractive index of the base material and the refractive index of the first material layer is smaller than or equal to 0.075.

7. The light emitting module according to claim 1, wherein the light uniformization structure further comprises:
a base material, a surface of the base material touching the second surface of the second material layer;
wherein the first material layer is located in a side of the second material layer opposite to the base material, and a difference between a refractive index of the base material and the refractive index of the second material layer is smaller than or equal to 0.075.

8. The light emitting module according to claim 1, wherein a plurality of microstructures are formed in both or either of the second surface of the first material layer and the second surface of the second material layer.

9. The light emitting module according to claim 1, wherein a ratio of a height of each microstructure to a distance between center points of any two neighboring microstructures among the microstructures is ≧0.3 and ≦0.5.

10. The light emitting module according to claim 1, wherein a number of the light source module is plurality and a ratio of a distance between two neighboring light source modules to a distance between each light source module and the light uniformization structure is ≦1 and ≧0.5.

11. A light uniformization structure, comprising:
a first material layer, being light transmissive and having a first surface and a second surface opposite to each other, wherein a plurality of microstructures is formed in the first surface of the first material layer;
a second material layer, being light transmissive and having a first surface and a second surface opposite to each other, wherein a plurality of microstructures is formed in the first surface of the second material layer; and
a spacer layer, located between the first material layer and the second material layer, wherein a refractive index of the spacer layer is smaller than a refractive index of the first material layer and a refractive index of the second material layer.

12. The light uniformization structure according to claim 11, wherein a difference between the refractive index of the spacer layer and the refractive index of the first material layer is equal to or greater than 0.08, and a difference between the refractive index of the spacer layer and the refractive index of the second material layer is equal to or greater than 0.08.

13. The light uniformization structure according to claim 12, wherein the refractive index of the spacer layer is between 1 and 1.5, the refractive index of the first material layer is equal to or greater than 1.5, and the refractive index of the second material layer is equal to or greater than 1.5.

14. The light uniformization structure according to claim 11, wherein the second surface of the first material layer faces the first surface of the second material layer.

15. The light uniformization structure according to claim 14, wherein the second surface of the first material layer touches apexes of the microstructures in the first surface of the second material layer.

16. The light uniformization structure according to claim 11, further comprising:
a base material, a surface of the base material touching the second surface of the first material layer;
wherein the second material layer is located in a side of the base material opposite to the first material layer, and a difference between a refractive index of the base material and the refractive index of the first material layer is smaller than or equal to 0.075.

17. The light uniformization structure according to claim 16, wherein the base material is a material having the refractive index equal to or greater than 1.49.

18. The light uniformization structure according to claim 11, further comprising:
a base material, a surface of the base material touching the second surface of the second material layer;
wherein the first material layer is located in a side of the second material layer opposite to the base material, and a difference between a refractive index of the base material and the refractive index of the second material layer is smaller than or equal to 0.075.

19. The light uniformization structure according to claim 18, wherein the base material is a material having the refractive index equal to or greater than 1.49.

20. The light uniformization structure according to claim 11, wherein a plurality of microstructures are formed in both or either of the second surface of the first material layer and the second surface of the second material layer.

21. The light uniformization structure according to claim 11, wherein a ratio of a height of each microstructure to a distance between center points of any two neighboring microstructures among the microstructures is ≧0.3 and ≦0.5.

22. The light uniformization structure according to claim 11, wherein the microstructures in the first surface of the first material layer form one of a stripe pattern, a mesh pattern, and a concentric-circle pattern, and the microstructures in the first surface of the second material layer form one of a stripe pattern, a mesh pattern, and a concentric-circle pattern.

23. The light uniformization structure according to claim 11, wherein each microstructure is one of a raised structure and a recessed structure, and has a shape of one of a columnar structure, a V-shaped structure, a spherical structure, or an aspherical structure.

24. The light uniformization structure according to claim 23, wherein the aspherical structure is a curved surface, and the curved surface satisfies the following equation:
$$Z = \frac{{cr}^{2}}{( 1 + {( 1 - ( 1 + k ) {c}^{2} {r}^{2} )}^{\frac{1}{2}} )}$$
where Z represents a perpendicular distance between a tangent of an apex of the curved surface and a line passing through a lowest point of the curved surface and parallel to the tangent of the apex, c is a curvature of the apex of the curved surface, k is a conic constant, and r is a radial radius of the curved surface.
